(19) United States
(12) Patent Application Publication
(10) Pub. No.: US 2017/0104781 A1
(43) Pub. Date: Apr. 13, 2017

(54) System and Method for Securing Server Data

(71) Applicant: Michael C. Wood, Lazy Lake, FL (US)

(72) Inventor: Michael C. Wood, Lazy Lake, FL (US)

(21) Appl. No.: 15/289,690

(22) Filed: Oct. 10, 2016

Related U.S. Application Data
(60) Provisional application No. 62/240,109, filed on Oct. 12, 2015.

(51) Int. Cl. H04L 29/06; G06F 17/30; G06Q 10/08; G06F 21/62; G06Q 20/38

(52) U.S. Cl. CPC H04L 63/1433; H04L 63/102; G06F 21/6245; G06Q 20/385; H04L 63/0245; G06Q 10/083; G06F 17/30864

(57) ABSTRACT

A system is described for securing data saved on servers against external security threats. The system includes a computing device connected to a data vault via a communications network and a server. The data vault stores personal information of a user. An alias is assigned to the personal information so that it is not disclosed during processing of a transaction by a server. When the user desires to complete a purchase, the user logs into a website having access to the server. To complete a purchase, the server queries the data vault for the user's sensitive personal information. The data vault responds with the aliases corresponding to the user's personal information so that the user may select payment and shipping information from among the aliases. Payment and shipping information are confirmed by selecting the desired aliases, which the server then transmits to the data vault for completion of the transaction.

### CROSS-REFERENCE TO RELATED APPLICATIONS

This application is a nonprovisional application of and claims priority from U.S. provisional patent application Ser. No. 62/240,109 filed on Oct. 12, 2015. U.S. Nonprovisional patent application Ser. No. 14/706,459, filed May 7, 2015; U.S. Provisional Application Ser. No. 62/192,365 filed Jul. 14, 2015; U.S. Provisional Application Ser. No. 62/295,315 filed Feb. 15, 2016; U.S. Provisional Application Ser. No. 62/308,205 filed Mar. 14, 2016; and U.S. Provisional Application Ser. No. 62/314,225 filed Mar. 28, 2016; U.S. Provisional Application Ser. No. 62/328,912 filed on Apr. 28, 2016; U.S. Provisional Application Ser. No. 62/333,755 filed on May 9, 2016; and U.S. Nonprovisional patent application Ser. No. 15/178,123 filed on Jun. 9, 2016; and U.S. Provisional Application Ser. No. 62/348,518 filed on Jun. 10, 2016; U.S. Provisional Application Ser. No. 62/350,556 filed on Jun. 15, 2016; Provisional Patent Application Ser. No. 62/354,588 filed on Jun. 24, 2016; U.S. Nonprovisional patent application Ser. No. 15/206,594 filed on Jul. 11, 2016; and U.S. Nonprovisional Patent Application Ser. No. 62/395,021 filed on Sep. 15, 2016 (all of the foregoing collectively referred to herein as the “Incorporated Applications”) are incorporated herein in their entirety by reference.

### FIELD OF THE INVENTION

The invention relates to systems and methods for securing server data. More particularly, the invention relates to systems and methods for securing data saved on servers against external security threats from hackers.

### BACKGROUND

Identity theft is the most common objective of most computer hackers. Personal identity information typically resides in one of two places: on client devices (e.g., on computers, tablet computers, mobile phones, and other personal computing devices), and/or on servers. Talker talker-based firewalls protect identity data and other data stored on client devices; however, such firewalls do not protect data that is stored on servers.

A need exists for protecting identity data and other data stored on servers by securing it from hackers who attempt to remotely access the server without authorization. A further need exists to secure the data stored on servers without impairing the functionality of the server for storing and making accessible such data to authorized users.

### SUMMARY

The invention relates to systems and methods for securing data saved on servers against external security threats from hackers by segregating personal identity information onto a separate server in a “data vault.” Personal identity information is transmitted to the data vault and each item of personal identity information is tagged with an alias. When software on other remote servers send a query requesting the personal identity information, for example, as when credit card payment information is being requested, only the aliases stored in the data vault can be read. In one embodiment, the data vault accepts three types of commands from the server: write, read, and execute. Both the personal identity information data and associated aliases are allowed to be written to the data vault, but only aliases can be read from the data vault. Because the remote server cannot access the personal identity information itself, the personal identity information is fully protected from hackers even if the server is under the complete control of a hacker.

The system and related methods provide an advantage in that they permit personal information of users to be securely stored on servers without impairing the functionality of the server. Personal information can consist of at least one item of: the user's name, address, e-mail address, phone number, identification number, birth date, credit card number, debit card number, bank account number, passwords, email contents, text or other messaging contents, contact information, and a shipping address that is different than the user's address.

The system and related methods provide another advantage by isolating the location where the personal information of users is saved from the Internet-facing server used by users via a website to make purchases of goods and services. In this way, hackers seeking to intercept traffic between the user's computing device and the website server cannot obtain the personal information, which is masked by an alias assigned by the user and stored in the data vault in a database that relates the alias to the user's personal information. Hackers also cannot obtain the personal information of users by taking control of the website server because no personal information is stored on the website server.

Accordingly, the invention features a system for securing data saved on servers against external security threats from hackers. The system includes a server, a computing device, and a data vault. The server is connected to a communications network, and the computing device can access a website to communicatively connect to the server via the communications network. The data vault stores personal information of a user that is transmitted by the user to the data vault from the computing device or from a different computing device. An alias is assigned by the user to the personal information. When the user desires to make a purchase as can be indicated using standard features of a retail website, the server transmits a query for the personal information to the data vault. The data vault transmits the alias to the server in response to the query received from the server for the personal information.

In another aspect, the invention can feature the data vault being or being hosted on a black box, a computer, a tablet computer, a mobile phone, a server, or any other suitable programmable device.

In another aspect, the invention can feature the communications network being the Internet.

In another aspect, the invention can feature the personal information including at least one item of personal information of the user selected from the group consisting of: the user's name, address, e-mail address, phone number, identification number, birth date, credit card number, debit card number, bank account number, and a shipping address that is different than the user's address.

In another aspect, the invention can feature an alias firewall that discards all communications from the server to the data vault that are not properly formatted read and write commands.

In another aspect, the invention can feature the data vault including the personal information stored in databases and software for organizing and accessing those databases via the computing device and communications network.

The invention also features a system for securing data on servers against external security threats. The system includes a data vault and a second server. The data vault is stored on a first server. The data vault includes personal information of a user, which is assigned an alias. The second server transmits a query to the data vault via a communications network requesting the personal information from the data vault in order for the second server to complete a transaction. The data vault transmits a response that includes the alias for a selection of the alias by the user. The first server completes the transaction based on the selection of the alias made by the user.

In another aspect, the invention can feature the communications network being the Internet.

In another aspect, the invention can feature the personal information including at least one item of personal information of the user selected from the group consisting of: the user's name, address, e-mail address, phone number, identification number, password, birth date, credit card number, debit card number, and bank account number.

In another aspect, the invention can feature the second server being a remote website server accessible through the communications network via a retail website. The transaction can be a purchase of goods or services. The user selects goods or services for purchase. The second server receives from the user and transmits to the data vault the personal information and assigned alias but does not store a copy.

In another aspect, the invention can feature the system including an alias firewall for filtering communications between the data vault of the first server and the second server.

In another aspect, the invention can feature the system including a name-based firewall for filtering communications between the data vault of the first server and a local area network to which non-alias personal information is transmitted from the data vault by the first server.

A method of the invention can be used to secure data on servers against external security threats. The method can include the steps of: (a) using a computing device, accessing a remote website server via a website through a communications network and registering as a new user of the website by selecting and entering a user name and a password that will be associated with the user name for purposes of logging into the website; (b) using the website, transmitting at least one item of personal information to a data vault for storage, wherein the user assigns a unique alias to each at least one item of personal information, wherein each at least one item of personal information and its associated alias are associated with the user name in the data vault; (c) using the website, selecting goods or services to purchase; (d) querying the data vault for at least one item of the personal information; (e) transmitting to the remote website server as a response from the data vault aliases corresponding to the at least one item of personal information previously entered and submitted by the user to the data vault; and (f) using a secured talker-protected communication line, executing a charge with a payment processor to complete a purchase of the goods or services by transmitting at least one item of personal information to the payment processor.

Another method of the invention can include the data vault being hosted on a second remote server that is different than the remote website server that hosts the website.

Another method of the invention can include step (b) of the method further including first transmitting the at least one item of personal information to the remote website server and immediately transmitting, without storing, the at least one item of personal information from the remote website server to the data vault.

Another method of the invention can include step (b) of the method further including querying the at least one item of personal information directly from the data vault using the computing device so that the at least one item of personal information is transmitted directly to the data vault and is not transmitted through the remote website server.

Another method of the invention can include the at least one item of personal information including at least one shipping address and at least one payment information submitted by the user through the website for storage in the data vault.

Another method of the invention can include each at least one shipping address being associated with the unique alias assigned to it by the user and each at least one payment information being associated with the unique alias assigned to it by the user.

Another method of the invention can include, after step (f), the method further including the step of: (g) transmitting the at least one personal information including a shipping address to a shipping label printer.

Another method of the invention can feature the data vault solely accepting queries for each at least one item of personal information and its associated alias from the remote website server, and the data vault solely sending responses to the server, wherein the responses include the associated alias for each at least one item of personal information.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a schematic diagram showing processes of a system for securing server data.

FIG. 2 is a schematic diagram showing processes of another system for securing data, which includes firewalls.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

The invention provides a system for securing data saved on servers against external security threats from hackers. All Internet-facing servers are vulnerable to hacking to one degree or another. Therefore, to provide maximum security from such hacking breaches, identity data can be stored elsewhere. The systems and methods described herein relate to a “data vault” for securely storing personal identity information while maintaining its accessibility for use by a user. The data vault and personal identity information stored therein can include databases and software for organizing and accessing those databases stored on one or more remote servers to which a user may communicatively connect via a computer having a connection to a telecommunications network. In exemplary embodiments, the telecommunications network is the Internet. In other embodiments, the telecommunications network can be a local area network (LAN), a wide area network (WAN), a virtual private network (VPN), or other suitable type of computer network. The one or more remote servers may be accessed through the telecommunications network on the user's computer via web browser software, by downloadable software installed on the user's computer for use in transmitting to the server and accessing personal identity information stored on the server, or by non-downloadable software accessed via the Internet, for example, through a website.

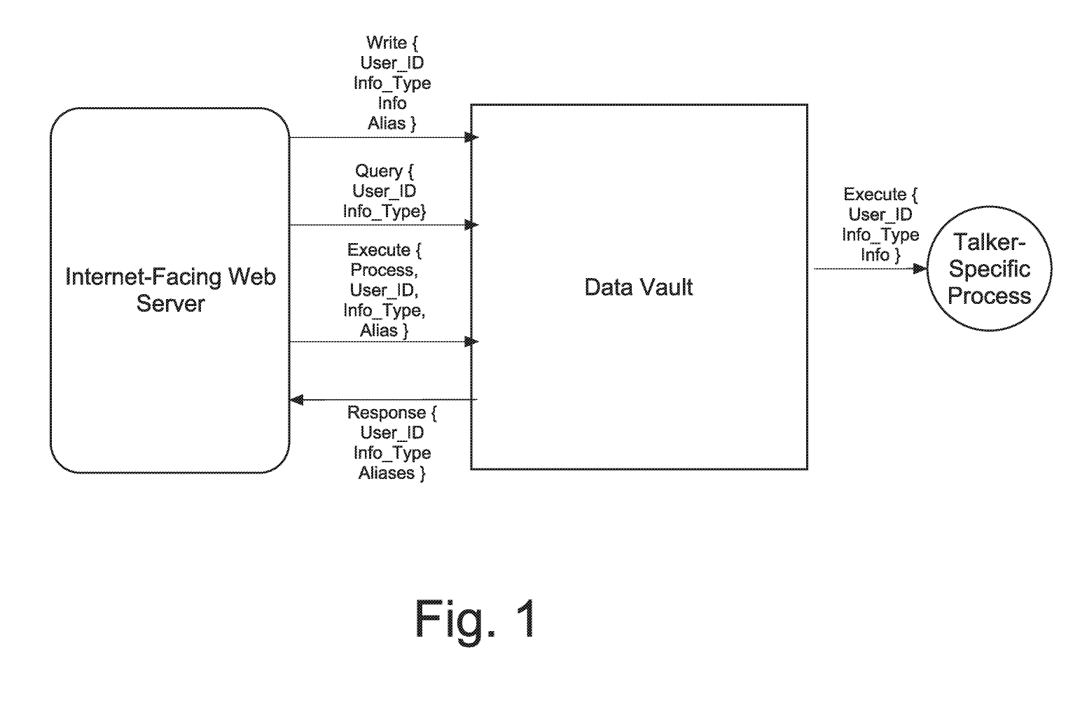

In one embodiment, the data vault accepts three types of commands from the server: write, read, and execute. An example of this embodiment is shown in FIG. 1. The key to making data unhackable is to allow both the data and associated aliases to be written to the data vault while only aliases can be read from the data vault. If the server cannot access the information itself, then the information is fully protected from hackers even if the server is under the complete control of hackers. In other embodiments, the data vault may accept more types of commands than the three aforementioned commands.

While innumerable possible syntaxes exist to represent these functions, the following example uses “Post” for writing, “Get” for reading, and “Process” for executing. Furthermore, by way of example only and without limitation, the following command syntaxes will be used herein in describing the systems and methods:

Post Info_Type {Info_Input} Alias {Alias_Input} For {User_ID}

Get Info_Type for {User_ID}

Process Process_Type {Process Input} for User_ID

### EXAMPLE

A user joins a new product-oriented website called CheapStuff.com. The user selects User_ID “Thrifty” and enters in a password as well. The server stores the User ID along with a one-way hash of the Password. The user then enters in his home address and assigns this address the following alias: “My Home.” The server sends the following to the Data Vault:
Post Address {694 Primrose Lane, No Real City, Ohio , 12345}
Alias {My Home}
For {Thrifty}

The server does not store this information but merely transmits it to the data vault. (In an alternate embodiment, the data vault can be used to query this information so that the information does not pass through the server at all. While the rest of the example involves a server query, all queries could come directly from the data vault itself.)

The user has joined the website in order to purchase and send some cheap stuff to his mother as gifts for her birthday. Therefore, the user enters in his mother's address (along with the alias “Mom's House”). The server sends the following to the data vault:
Post Address {342 Liberty Lane, Another Fake City, Calif., 54321}
Alias {Mom's House}
For {Thrifty}

The user then enters in a credit card number (and its expiration date and/or security code) and assigns to it the alias “Bank of America.” The server then sends the following to the data vault:
Post Visa {1234 5678 9101 1121, 4/17, 321}
Alias {Bank of America}
For {Thrifty}

The user enters in another credit card number (e.g., one with the alias “Chase”). The server sends the following to the data vault:
Post MasterCard {1111 1111 1111 1111, 8/19, 123}
Alias {Chase}
For {Thrifty}

Using the website, the user then selects some cheap birthday gifts for his mother:
(1) Extra-Cheap Perfume—Product Number 089
(2) Super-Cheap Lamps—Product Number 312

The total purchase price is $12.54.

At checkout, the server queries the data vault for all addresses:
Get Address
For Thrifty

The data vault sends back the following:
Address for Thrifty {My House, Mom's House}

Note that the data vault only sends the aliases. The actual addresses are inaccessible to the server (and therefore, are inaccessible to any would-be hacker as well).

The server displays the two address aliases. The user selects “My House” for the billing address for the purchase and he selects “Mom's House” for the shipping address.

The user then selects the slowest (cheapest) shipping, which now brings the total to $15.88.

Next, the server queries the data vault for the credit card payment information:
Get PaymentOptions
For Thrifty

The data vault sends back the following:
PaymentOptions for Thrifty {Bank of America, Chase}

Note once again that the data vault only sends the aliases in response to the query. The actual credit card numbers are inaccessible to the server (and therefore, are inaccessible to any would-be hacker as well).

The user chooses “Chase” as the method of credit card payment. The server then sends the following to the data vault:
Process CreditCharge {Chase, My House, $15.88}
For Thrifty

The data vault then uses a secured talker-protected communication line (e.g., using the talker-based firewall previously disclosed in U.S. patent application Ser. No. 14/706,459 and the other Incorporated Applications) to execute the charge with the credit card processing center. Assuming that the charge is approved by the credit card processing center, the data vault responds:
CreditCharge {Approved} for Thrifty
Next, the server sends the following to the data vault:
Process PrintShippingLabel {Mom's House}
For Thrifty

The data vault sends the shipping address (in this example, Mom's Address) directly to the shipping label printer using a secured talker-protected communication line (e.g., using the talker-based firewall previously disclosed in U.S. patent application Ser. No. 14/706,459 and the other Incorporated Applications).

Next, the server sends the following to the data vault:
Process PrintPackingSlip {1, 089, 2, 312, My House, Mom's House}
For Thrifty

The above instructions include the quantities, product numbers, billing address, and shipping address. The data vault sends this information to the packing slip printer using a secured talker-protected communication line (e.g., using the talker-based firewall previously disclosed in U.S. patent application Ser. No. 14/706,459 and the other Incorporated Applications).

In alternate embodiments, the printer(s) can be directly attached to the data vault.

In this manner, all personal data remains inaccessible to hackers, even if they gain control over the company's servers (in the example above, over CheapStuff.com's servers). Also, the company still has full flexibility to write any type of web program it desires, however, any such web program will only display aliases in lieu of actual personal identity information. Thus, once again, maximum security has been achieved while preserving maximum convenience as well.

The data vault can be a black box or a programmable device itself (i.e., a computer device such as, for example, a computer, a tablet computer, a mobile phone, or a server). In one embodiment, if a computer device is used then a protocol firewall can be placed between the server and the data vault. Such a protocol firewall can examine all communication to make sure that it solely involves accepted commands (e.g., Post Visa, Get Address, etc.). All communication that is not an accepted command will be discarded by the protocol firewall thereby rendering it impossible for the hacker to circumvent the system.

The invention also relates to methods for protecting and securing data saved on servers against external security threats from hackers by securely storing personal identity information related to users in a data vault located on a remote data vault server. Accessibility to the personal identity information is maintained for use by a user. The method can include the step of registering as a new user of a website, e.g., a retail store website. In this step, the new user can select and enter a user name that will be associated with the user as well as a password that will be associated with the user name for purposes of logging into the website. Another step of the method can include submitting the user's address (e.g., home address or business address) through the website and assigning an alias (e.g., “My Home” or another suitable alias) that will be associated with the user's address and user name in the data vault. In the steps of this method, the website being accessed by the user from the user's computer via the Internet or other telecommunications network can be hosted on a remote website server that is different from the remote data vault server on which the data vault is located. The remote website server merely receives the personal identity information submitted by the user and immediately transmits the personal identity information to the data vault so that the remote website server does not store any of the personal identity information requested by the website and submitted by the user from the user's computer. The remote data vault server writes and stores all transmitted personal identity information that is received from the user via submission through the website and the remote website server.

In an alternate embodiment, the data vault can be used to query this information from the user so that the personal identity information is transmitted directly to the remote data vault server and does not pass through the remote website server.

In a next step of the method, in order to purchase goods or services from the retail website, the user can enter and submit a shipping address that is transmitted through the website to the data vault where it is stored. The shipping address can be the user's address or a different address of the user. In one embodiment, the shipping address can be the address of another party, e.g., another person who is a gift recipient where the goods or services purchased by the user through the website are a gift for the gift recipient.

In a next step of the method, the user can enter and submit payment information (e.g., credit card number and information) that is transmitted through the website to and stored in the data vault for future use in making purchases via the website. In this step, an alias is associated and transmitted with the payment information. For example, the alias selected and submitted by the user for a particular credit car could be the card issuing company's name. In this step, the user may enter and submit more than one payment information, e.g., payment information related to two different credit cards, each of which may be used as payment options in a later step of the method.

In a next step of the method, using the website, the user can select the goods or services that the user desires to purchase. A total purchase price may be provided to the user on the website at this step or at a later step of the method.

In a next step of the method, the remote website server can query the remote data vault server for addresses associated with the user's user name, and the data vault can respond with the user's address, shipping address, and any other addresses entered and submitted by the user from which the user may select one as a billing address for making payment for the purchased goods or services through the website and another as a shipping address for purposes of having the purchased goods shipped thereto. The billing address and the shipping address may be the same or different addresses. If services rather than goods were purchased by the user, depending on the nature of the services, the user may not be required to select a shipping address in this step.

In an optional step of the method, the website may ask the user to select a shipping option, e.g., standard shipping or overnight shipping, for sending the goods to the shipping address. The total purchase price may be adjusted in this optional step to add any shipping charges to the total price being paid by the user.

In a next step of the method, the remote website server queries the remote data vault server for payment information, and the data vault responds with any payment aliases (e.g., credit card aliases) previously entered and submitted to the data vault by the user. The user can select one of the payment aliases for making payment for the current purchase of goods or services.

In a next step of the method, the remote data vault server can use a secured talker-protected communication line (e.g., using the talker-based firewall previously disclosed in U.S. patent application Ser. No. 14/706,459 and the other Incorporated Applications) to execute the charge with a payment processor, e.g., with a credit card processing center. Assuming that the payment attempt is approved by the payment processor, the remote data vault server sends the shipping address directly to a shipping label printer using a secured talker-protected communication line (e.g., using the talker-based firewall previously disclosed in U.S. patent application Ser. No. 14/706,459 and the other Incorporated Applications).

In an optional step of the method, the remote data vault server can also send instructions including, without limitation, the quantity of purchased goods, product numbers for the purchased goods, billing address, and shipping address, to a packing slip printer using a secured talker-protected communication line (e.g., using the talker-based firewall previously disclosed in U.S. patent application Ser. No. 14/706,459 and the other Incorporated Applications) so that the appropriate type and quantity of goods purchased by the user can be packed and shipped to the shipping address selected by the user.

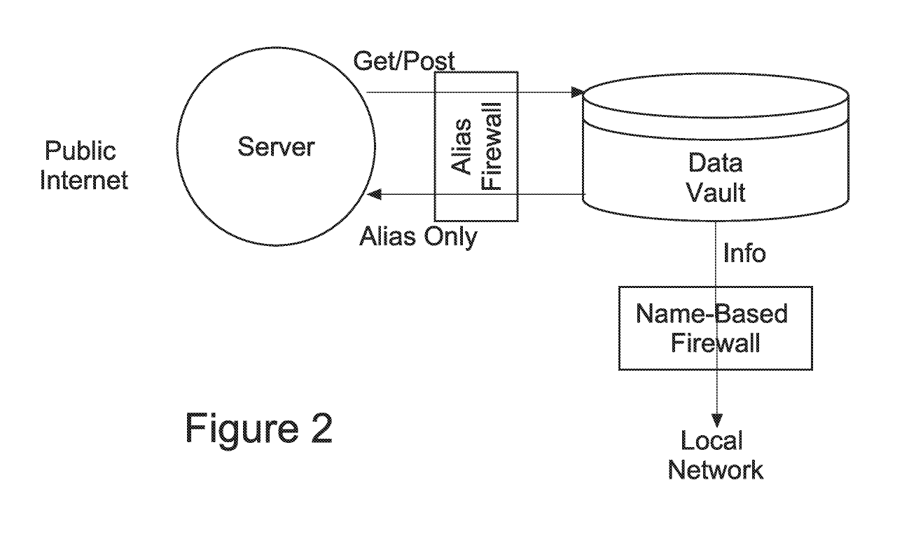

As shown in FIG. 2, the system can include one or more firewalls. For example, the system can include an alias firewall. The system could also include a name-based firewall. In other embodiments, the system may not include any firewalls. The alias firewall discards all communication from the server that is not a properly formatted Get/Post (i.e., read and write) command. The data vault solely sends alias data to the server. The server solely sends non-alias information (i.e. actual information not masked by an alias) to a communications network (e.g., the LAN shown in FIG. 2) through a name-based firewall connection, thereby ensuring that the actual information for which protection from disclosure is desired solely goes to preapproved entities. In this way, users' personal identity information is safe and protected from theft via hacking, even if a hacker gains total control of the Internet-facing server. Moreover, the actual information is protected from disgruntled employees via the name-based firewall.

As previously mentioned, not all embodiments of the system must include firewalls. The important features of the system are that the data vault solely accepts Get/Post commands (or the like) from the server, and the data vault solely sends alias information (e.g., of the types set forth in the example above) to the server. With these two features, user personal identity information is safe and secure from security threats, even if a hacker gains total control of the Internet-facing server.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A system for securing data saved on servers against external security threats from hackers, the system comprising:
a server connected to a communications network;
a computing device for accessing a server via the communications network; and
a data vault that stores personal information of a user; and
wherein an alias is assigned to the personal information; and
wherein data vault transmits the alias to the server in response to the query received from the server for the personal information.

2. The system of claim 1, wherein the data vault comprises a black box, a computer, a tablet computer, a mobile phone, a server, or any other suitable programmable device.

3. The system of claim 1, wherein the communications network comprises the Internet.

4. The system of claim 1, wherein the personal information comprises at least one item of personal information of the user selected from the group consisting of: the user's name, address, e-mail address, phone number, identification number, birth date, credit card number, debit card number, bank account number, and a shipping address that is different than the user's address.

5. The system of claim 1, comprising an alias firewall that discards all communications from the server to the data vault that are not properly formatted read and write commands.

6. The system of claim 1, wherein the data vault comprises the personal information stored in databases and software for organizing and accessing those databases via the computing device and communications network.

7. A system for securing data on servers against external security threats, the system comprising:
a data vault stored on a first server, wherein the data vault comprises personal information of a user, wherein the personal information is also assigned an alias;
a second server that transmits a query to the data vault via a communications network requesting the personal information from the data vault in order for the second server to complete a transaction;
wherein the data vault transmits a response that comprises the alias for a selection of the alias by the user;
wherein the first server completes the transaction based on the selection of the alias made by the user.

8. The system of claim 7, wherein the communications network comprises the Internet.

9. The system of claim 7, wherein the personal information comprises at least one item of personal information of the user selected from the group consisting of: the user's name, address, e-mail address, phone number, identification number, password, birth date, credit card number, debit card number, and bank account number.

10. The system of claim 7, wherein the second server is a remote website server accessible through the communications network via a retail website;
wherein the transaction is a purchase of goods or services;
wherein the user selects goods or services for purchase; and
wherein the second server receives from the user and transmits to the data vault the personal information and assigned alias but does not store a copy.

11. The system of claim 7, wherein the system comprises an alias firewall for filtering communications between the data vault of the first server and the second server.

12. The system of claim 7, wherein the system comprises a name-based firewall for filtering communications between the data vault of the first server and a local area network to which non-alias personal information is transmitted from the data vault by the first server.

13. A method for securing data on servers against external security threats, the method comprising the steps of:
(a) using a computing device, accessing a remote website server via a website through a communications network and registering as a new user of the website by selecting and entering a user name and a password that will be associated with the user name for purposes of logging into the website;
(b) transmitting at least one item of personal information to a data vault for storage, wherein the user assigns a unique alias to each at least one item of personal information, wherein each at least one item of personal information and its associated alias are associated with the user name in the data vault;
(c) selecting goods or services to purchase;
(d) querying the data vault for at least one item of the personal information;
(e) transmitting to the remote website server as a response from the data vault aliases corresponding to the at least one item of personal information previously entered and submitted by the user to the data vault; and
(f) using a secured talker-protected communication line, executing a charge with a payment processor to complete a purchase of the goods or services by transmitting at least one item of personal information to the payment processor.

14. The method of claim 13, wherein the data vault is hosted on a second remote server that is different than the remote website server that hosts the website.

15. The method of claim 13, wherein step (b) of the method comprises first transmitting the at least one item of personal information to the remote website server and immediately transmitting, without storing, the at least one item of personal information from the remote website server to the data vault.

16. The method of claim 13, wherein step (b) of the method comprises querying the at least one item of personal information directly from the data vault using the computing device so that the at least one item of personal information is transmitted directly to the data vault and is not transmitted through the remote website server.

17. The method of claim 13, wherein the at least one item of personal information comprises at least one shipping address and at least one payment information submitted by the user through the website for storage in the data vault.

18. The method of claim 17, wherein each at least one shipping address comprises the unique alias assigned to it by the user; and wherein each at least one payment information comprises the unique alias assigned to it by the user.

19. The method of claim 13, wherein after step (f), the method further comprises the step of:
(g) transmitting the at least one personal information comprising a shipping address to a shipping label printer.

20. The method of claim 13, wherein the data vault solely accepts queries for each at least one item of personal information and its associated alias from the remote website server, and the data vault solely sends responses to the server, wherein the responses comprise the associated alias for each at least one item of personal information.
